(19) United States
(12) Patent Application Publication
(10) Pub. No.: US 2014/0151273 A1
(43) Pub. Date: Jun. 5, 2014

(54) PROBE ARRANGEMENT FOR A FLOTATION CELL

(71) Applicants: Anssi Lehikoinen, Kuopio (FI); Marko Vauhkonen, Kuopio (FI)

(72) Inventors: Anssi Lehikoinen, Kuopio (FI); Marko Vauhkonen, Kuopio (FI)

(73) Assignee: OUTOTEC OYJ, Espoo (FI)

(21) Appl. No.: 14/239,197

(22) PCT Filed: Aug. 18, 2011
(86) PCT No.: PCT/FI2011/050727

§ 371 Date: Feb. 17, 2014

(51) Int. Cl. B03D 1/02; G01N 27/04

(52) U.S. Cl. CPC B03D 1/028; G01N 27/04
USPC 209/164; 324/713

(57) ABSTRACT

The flotation process is widely used in mineral industry for the separation of minerals from low-grade ore slurry. Several parameters, such as the bubble size distribution and/or amount of solids in the froth and slurry affect the outcome of the flotation process. To be able to monitor these parameters, knowledge of the temporal changes of froth-slurry phase interface as well as froth-air interface is essential. In the present invention, an electrical resistance tomography probe sensor, which is capable of analyzing the properties of froth and slurry based on the correlation between the estimated conductivity information and the parameters of interest, is introduced.

### BACKGROUND OF THE INVENTION

1. Field of the Invention

The present invention relates to interface level measurements in a tank or container comprising different material layers and especially to flotation processes which are especially applied in mineral industry, for instance.

2. Description of the Related Art

Flotation process is commonly used e.g. in mining industry. A process called froth flotation is used to separate useful minerals from the gangue (non-useful minerals or metals). The ore material is ground into fine-grained powder which is mixed with water. Such slurry is provided with a surfactant chemical which changes the desired mineral or material as hydrophobic. The remaining gangue material remains as non-hydrophobic. Such a mixture of materials is further added with water and provided with air, in order to create bubbles to the slurry. The hydrophobic desired mineral is attached to the air bubbles which further rises to the top of the slurry to form a froth layer. Such froth can be separated from the flotation cell and processed further.

There are several parameters that affect the outcome of the flotation process: air distribution, size distribution of the air bubbles, material flow dynamics, the type and amount of mineral, etc.; see “Koh, P., Schwartz, M., 2006: FD modeling of bubble-particle attachments in flotation cells; Minerals Engineering 19, p. 619-626”. Some non-invasive or invasive imaging techniques exist which can be utilized in studying these parameters. Examples of such techniques are Laser Doppler Velocimetry (LDV), Phase Doppler Abenometry (PDA) and high-speed video imaging, see “Miettinen, T., Laakkonen, M., Aittamaa, J., Nov. 3-8, 2002; The applicability of various flow visualisation techniques for the characterisation of gas-liquid flow in a mixed tank; Proc AIChE Annual Meeting, Indianapolis, USA, p. 177h” and “Tiitinen, J., Vaarno, J., Grönstrand, S., Dec. 10-12, 2003; Numerical modeling of an Outokumpu flotation device; Proc Third International Conference on CFD in Minerals and Process Industries, CSIRO, Melbourne, Australia”.

Also conductivity probes, ultrasonic techniques, floats and pressure transducers have been tested but no reliable commercial equipment is available, see “M. Maldonado, A. Desbiens, R. del Villar: An update on the estimation of the froth depth using conductivity measurements, Minerals Engineering, 935-939, 2008”.

Similar approaches have been introduced in “Normi V., Lehikoinen A., Mononen M., Rintamäki J., Maksimainen T., Luukkanen S., Vauhkonen M.: Predicting collapse of the solid content in a column flotation cell using tomographic imaging technique, Proc. of Flotation09, South-Africa, 2009”, “Vergouw J., Gomez C. O., Finch J. A.: Estimating true level in a thickener using a conductivity probe, Minerals Engineering, 17:87-88, 2004” and in WO 93/00573 (“Schakowski et al.: Interface level detector, 1993”).

Regarding investigation of the properties of the material, one useful technique is impedance tomography or impedance spectroscopy tomography. The word “tomography” usually refers to cross-sectional imaging. It is generally meant by impedance tomography the electrical measurements made by means of electrodes placed on the surface of or within the target, and determination of the electrical conductivity distribution of the target based on the measurements. Areal variations in the conductivity determined as a result of the impedance tomography indicate variations in the quality of the flowing mass and this can thus give information e.g. about gas bubbles or other non-uniformities among the measured material. In typical measurements, current or voltage is supplied between two particular electrodes and the voltage or the current, correspondingly, is measured between these or between some other pair(s) of electrodes. Naturally, several pairs of supplying as well as measuring electrodes can be used simultaneously. By impedance tomography, in its basic form, is usually meant measurements carried out at one single frequency. When impedance measurements in general are performed at several frequencies over a specified frequency range, conventionally used term is impedance spectroscopy. The technology where the aim is to produce reconstructions, i.e. tomography images over a frequency range, is called as Electrical Impedance Spectroscopy Tomography (EIST). Subsequentially, the expression “impedance tomography” is used to cover both the impedance tomography in its conventional meaning and the EIST.

As stated above, in impedance tomography, an estimate of the electrical conductivity of the target as a function of location is calculated on the basis of measurement results. Thus, the problem in question is an inverse problem where the measured observations, i.e. the voltage or the current, are used to determine the actual situation, i.e. the conductivity distribution which caused the observations. The calculation is based on a mathematical model determining the relations between the injected currents (or voltages), the electrical conductivity distribution of the target, and the voltages (or currents) on the electrodes. The voltages and currents according to the model are compared with the supplied and the measured ones, and the differences between them are minimized by adjusting the parameters of the model (e.g. conductivity values) until the minimization is achieved in a desired accuracy. There are many possible algorithms available for such a minimization procedure.

All these techniques suffer from some limitations. For example, the high-speed imaging requires transparent dispersion and the size of the cell must be fairly small. In practical flotation situations, the cell is often opaque and in such a case the preceding techniques are commonly inappropriate. In addition, contamination of the measurement equipment is often a problem in many existing techniques.

### SUMMARY OF THE INVENTION

The present invention introduces a method for analyzing material in a container comprising slurry and/or froth and/or gas and/or a transitional area between the froth and the slurry, using at least one probe comprising together a plurality of electrodes capable of being in contact with the material, and the method comprises the steps of injecting currents or voltages through at least two electrodes; measuring voltages or currents, respectively, through the electrodes. The method is characterized in that conductivity distribution is determined for the material using model based calculations, which comprise reconstruction of a vertical conductivity profile among the material.

In an embodiment of the invention, the method further comprises determining properties of the material based on the voltage or current measurement results, the properties comprising at least one of bubble size distribution, amount of solid materials in the froth and/or slurry, and stiffness of the froth.

In an embodiment of the invention, the method further comprises estimating interface levels between froth-slurry and/or froth-gas interfaces and/or between the transitional area and froth and/or between the transitional area and slurry.

In an embodiment of the invention, the method further comprises estimating the slurry-froth interface level and/or the froth-gas interface level by a step-like change in the conductivity value of the interface.

In an embodiment of the invention, the method further comprises estimating the density of the froth and/or the slurry, the density being proportional to the conductivity of the froth and/or the slurry.

In an embodiment of the invention, the method further comprises detecting electrodes locating in the gas, when the measured voltage or current by these electrodes is bound by a supply voltage of the system, or when the measured voltage is beyond an allowed measurement voltage range.

In an embodiment of the invention, the method is applied in a froth flotation process and the method further comprises controlling the froth flotation process based on at least one of the bubble size distribution, amount of solid materials in the froth and the slurry, stiffness of the froth and the interface levels between froth-slurry and/or froth-gas.

In an embodiment of the invention, the controlling step is realized by at least one of adding at least one additive material changing the stiffness of the froth, choosing rate of input material feed, choosing rate of aeration, and changing parameters of grinding.

In an embodiment of the invention, the method further comprises monitoring contamination of the electrodes by measuring contact impedances between each electrode and the material to be analyzed.

In an embodiment of the invention, the method further comprises using in the analysis visual inspection data taken by a video camera.

In an embodiment of the invention, the method further comprises measuring temperature with the at least one probe, and compensating conductivity values based on the measured temperature value.

According to another aspect of the invention, the inventive idea comprises a system for analyzing material in a container comprising slurry and/or froth and/or gas and/or a transitional area between the froth and the slurry. The system comprises a probe arrangement of at least one probe comprising together a plurality of electrodes capable of being in contact with the material, a current source configured to inject currents or voltages through at least two electrodes, measuring means configured to measure voltages or currents, respectively, through the electrodes, and a processor configured to control the measurements.

The system is further characterized in that the processor is configured to determine conductivity distribution for the material using model based calculations, which comprise reconstruction of a vertical conductivity profile among the material.

In an embodiment of the invention, the processor is further configured to determine properties of the material based on the voltage or current measurement results, the properties comprising at least one of bubble size distribution, amount of solid materials in the froth and/or slurry, and stiffness of the froth.

In an embodiment of the invention, the processor is further configured to estimate interface levels between froth-slurry and/or froth-gas interfaces and/or between the transitional area and froth and/or between the transitional area and slurry.

In an embodiment of the invention, the processor is further configured to estimate the slurry-froth interface level and/or the froth-gas interface level by a step-like change in the conductivity value of the interface.

In an embodiment of the invention, the processor is further configured to estimate the density of the froth and/or the slurry, the density being proportional to the conductivity of the froth and/or the slurry.

In an embodiment of the invention, the processor is further configured to detect electrodes locating in the gas, when the measured voltage or current by these electrodes is bound by a supply voltage of the system, or when the measured voltage is beyond an allowed measurement voltage range.

In an embodiment of the invention, the system is applied in a froth flotation process and the processor is further configured to control the froth flotation process based on at least one of the bubble size distribution, amount of solid materials in the froth and the slurry, stiffness of the froth and the interface levels between froth-slurry and/or frothgas.

In an embodiment of the invention, the controlling step is realized by at least one of adding at least one additive material changing the stiffness of the froth, choosing rate of input material feed, choosing rate of aeration, and changing parameters of grinding.

In an embodiment of the invention, the measuring means are configured to monitor contamination of the electrodes by measuring contact impedances between each electrode and the material to be analyzed.

In an embodiment of the invention, the system further comprises a video camera configured to take visual inspection data for use in the analysis.

In an embodiment of the invention, the system further comprises a temperature probe configured to measure temperature and connected to the at least one probe, and the system is configured to compensate conductivity values based on the measured temperature value.

According to the third aspect of the invention, the inventive idea comprises also a computer program for analyzing material in a container comprising slurry and/or froth and/or gas and/or a transitional area between the froth and the slurry, using at least one probe comprising together a plurality of electrodes capable of being in contact with the material. The computer program comprises code adapted to control the following steps, when executed on a data-processing system:
injecting currents or voltages through at least two electrodes;
measuring voltages or currents, respectively, through the electrodes;
   characterized in that the computer program is further adapted to:
determine conductivity distribution for the material using model based calculations, which comprise reconstruction of a vertical conductivity profile among the material.

In an embodiment of the invention, the computer program is stored on a computer readable medium.

### BRIEF DESCRIPTION OF THE DRAWINGS

FIG. 1 illustrates a froth flotation tank comprising a probe arrangement according to an example of the invention,

FIG. 2 shows a 3D reconstruction of a flotation tank and the location of the interface between different types of material, in one example of the invention,

FIG. 3 illustrates curves depicting the bubble size (in mm²) and the conductivity (in mS/cm) as a function of time, and

FIGS. 4a and 4b illustrate conductivity values of the material linked together with pictures showing relative stiffness of the material through visually observable bubble sizes.

### DETAILED DESCRIPTION OF THE EMBODIMENTS

Reference will now be made in detail to the embodiments of the present invention, examples of which are illustrated in the accompanying drawings.

The present invention introduces techniques based on computational electrical resistance tomography approach which is applied to be used with a probe arrangement. In this approach, metal electrodes can be attached on a surface of a probe, through which sinusoidal currents are injected and resulting voltages are measured through at least two electrodes. Alternatively, voltages can be supplied between any two of the electrodes, and the resulting currents may be measured through the electrodes. The electronics in the system hardware handles the injection, the measurements and the analysis performed based on the measurement results.

The probe arrangement may comprise one or more separate probes. The probe(s) is immersed in a flotation cell for analyzing properties of froth and/or slurry materials present in a froth flotation tank. If the slurry and froth layers are separated in a flotation tank, their mutual interface level location can be determined with the process according to the invention. The probe according to the invention is also capable of detecting and estimating the interface level of the froth-gas interface. Typically, there is also a transitional area between the froth and slurry volumes. The probe arrangement can be used to detect also the interfaces between the transitional area and the froth, and between the transitional area and the slurry.

A model based computational approach is utilized to analyze the measured data. This means that such an approach takes into account for instance the geometry of the probe, the geometry of the object being measured, as well as possible contamination of the electrodes. Through mathematical analysis of the model, the location of the different interfaces such as the froth-slurry interface can be detected, based on which the properties of the two media can further be analyzed in a desired manner.

The froth-air interface can be detected by two different methods. In both methods an injection signal, which can be either injected voltage or current, is applied to the electrodes. In the primary method of detecting the froth-gas interface, the injection electronics in the hardware detects whether the output signal is limited by the supply voltage and the waveform is therefore clipped. In this method, the injection signal is applied to the electrode pairs or between the electrode and signal ground in any order, and the first (uppermost) electrode that can be applied with an injection signal without clipping marks is determined as the first electrode just beneath the surface of the froth.

The second method of detecting the froth-gas interface is by measuring the voltages caused by the injection signal. The measurement is done in between any electrodes or between an electrode and the signal ground. When the measurement electronics detect that the measured signal voltage is beyond the allowed measurement voltage range, it is concluded that the electrode locates within the gas.

The first (uppermost) electrode or the electrode pair that detects a signal below the allowed limits marks the first electrode just beneath the surface of the froth. With combining these two methods or used as independently, the interface location determination between the gas and froth can be accomplished.

In an exemplary arrangement of the invention, the probe comprises 16 to 22 pieces of electrodes attacked to the surface of the probe or probes. However, other amount of electrodes is also applicable, but at least two electrodes are always needed for supplying and measuring voltages (or currents) between the electrodes. As already mentioned, the probe arrangement may comprise one or more separate probes. Each probe may comprise two or more electrodes. Furthermore, a single probe can be formulated as a straight piece of probe or it can be designed as an L-shaped, T-shaped probe or otherwise curved probe, for instance. In one example, the electrodes can be placed so that there are several electrodes on the same vertical layer, the probe having multiple of these layers. For instance, such an arrangement may comprise two layers with four electrodes on each layer, two layers with eight electrodes on each layer or four layers with sixteen electrodes on each layer. A genuine 3-dimensional illustration can be obtained from the observed volume with such electrode arrangements.

More precisely, the electrodes can be connected to the surface of a straight or formulated piece of metallic body in a way that a contact with surrounding material can easily be achieved. Also the alignment (angle) in which the straight, plane-like or formulated piece of probe is set in the froth flotation tank or other measurable volume, can be selected. The alignment information must be known in the control logic in order to maintain the location data of each electrode with good precision.

In one embodiment of the invention, the effect of contamination or dirtying of at least one electrode in the probe arrangement is taken into account. The contamination around the electrode(s) leads into a non-ideal connection between the metallic electrode and the material to be measured, which further causes additional electric resistance. The non-ideal connection can be seen as an additional voltage drop and it can be expressed by a quantity called contact impedance. The voltage (or current) measured through a pair of electrodes is generally a function of the injected current (or voltage), the conductivity distribution in the path of the electrical current and the contact impedances between the electrodes and the surrounding materials to be measured. The contact impedances may be used to compensate the dirtying of the electrodes by inserting them to the calculation model as additional voltage loss parameters.

Regarding the flotation cell in practice, there can be present three different phases: slurry and/or froth and in case both are present, the transitional area between them. The probe(s) according to the invention is capable to detect interfaces between the froth and the transitional area, between the transitional area and the slurry, and even inside the transitional area if the conductivity of the measured material changes notably within the transitional area. It is to be noted that the transitional area expands when the froth becomes stiffer. The froth stiffness means a property of the froth and it depends for example on the amount of solids and the size of the air bubbles in the froth and it is related to estimated froth conductivity.

The resulting properties of the slurry and froth can be used to enhance the process, e.g. by optimizing the operation in flotation cells to achieve better recovery efficiency. For example, froth collapse may be predicted by the froth stiffness data. The froth properties, such as the bubble size distribution, average bubble size, amount of solid materials among all the material (either absolutely or relatively) and the stiffness of the froth, are used in controlling the process to a more optimized configuration. An example of controlling the process accordingly is to add liquid, such as xanthate or oil, into the flotation chamber.

As an example, regarding the stiffness of the froth, conductivity value between 0.15 . . . 0.20 mS/cm means elastic froth which need not to be inspected constantly. Conductivity values between 0.20 . . . 0.25 mS/cm describe suitable stiffness but the froth still needs to be inspected in order to keep its stiffness in the suitable range. The conductivity values exceeding 0.25 mS/cm mean stiff froth which in the worst case may halt the whole flotation process. In an embodiment, suitable froth stiffness is selected based on the conductivity, in order to achieve an optimally functioning process. In an example, the conductivity of the froth is set to reach and be maintained in an optimal window of 0.21 . . . 0.23 mS/cm. However, this does not rule out the fact that also some other range can be found as optimal, regarding also that different processes and changes of other parameters may well require different optimal values for the material conductivity.

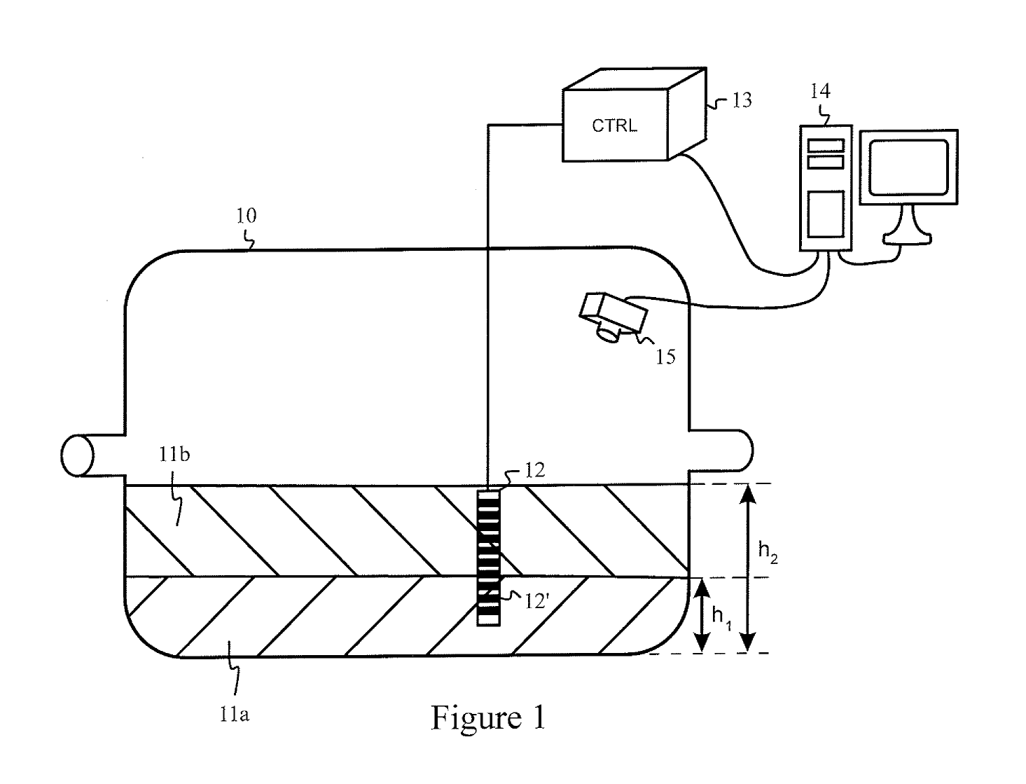

FIG. 1 illustrates a measurement arrangement in e.g. a froth flotation tank 10. Material can be fed into and away from the tank and the material comprises solid materials dissolved among the liquid material(s). At the bottom of the tank, separate volumes of slurry 11a and froth 11b are formed and layered. The interface level between the slurry 11a and froth 11b is marked as Y-coordinate h₁ and the interface level between the froth 11b and gas (air) is marked as h₂. There can also be a transitional layer between the slurry and froth layers 11a, 11b (not shown).

A probe arrangement comprising in this case a single probe 12 is lowered into the tank 10 and fixed preferably in its measurement position. The probe arrangement comprises a set of electrodes 12′. Ten electrodes are used in this exemplary case. In practice the probe is for instance lowered so that it has contact to both the slurry and froth volumes, and the uppermost electrode locates just beneath the froth surface and the probe is aligned in a vertical position. The Y-coordinates of the probe (and also its electrodes 12′) can be defined in relation to the material container, in a controller 13. The controller 13 may also take care of the current (or voltage) supply and voltage (or current) measurements between different pairs of electrodes 12′. A server or a computer 14 performs needed calculations and stores the required parameters. The measurement, analysis and calculation steps may be executed through a computer program implemented in the controller 13, server 14 or through an external server (not shown) locating remotely in the network. The process control means (providing a signal to change a parameter value, e.g. an input rate of the material to be fed into the process) can also be implemented through the controller 13 or server 14. It can be noted that the entity 13 may be a motor directing the probe arrangement and being aware of the orientation and location of the probe(s) all the time, while the entity 14 controls the motor and the overall flotation process.

Additionally, the system may comprise a camera 15 suitable to monitor the surface of the froth inside the flotation tank. This way it is possible to manually check the froth, e.g. bubble sizes of the froth surface. The picture data can be fed to the server 14 and/or it can be provided to manual inspection for the user. Furthermore, the picture data can be used e.g. for triggering an alarm in case the bubble size indicates froth collapsing or other crucial process situation requiring urgent action. In a preferred embodiment, the camera 15 is a video camera capable of taking pictures continuously, or it can be capable of taking still photographs in suitable time instants or in specified time intervals.

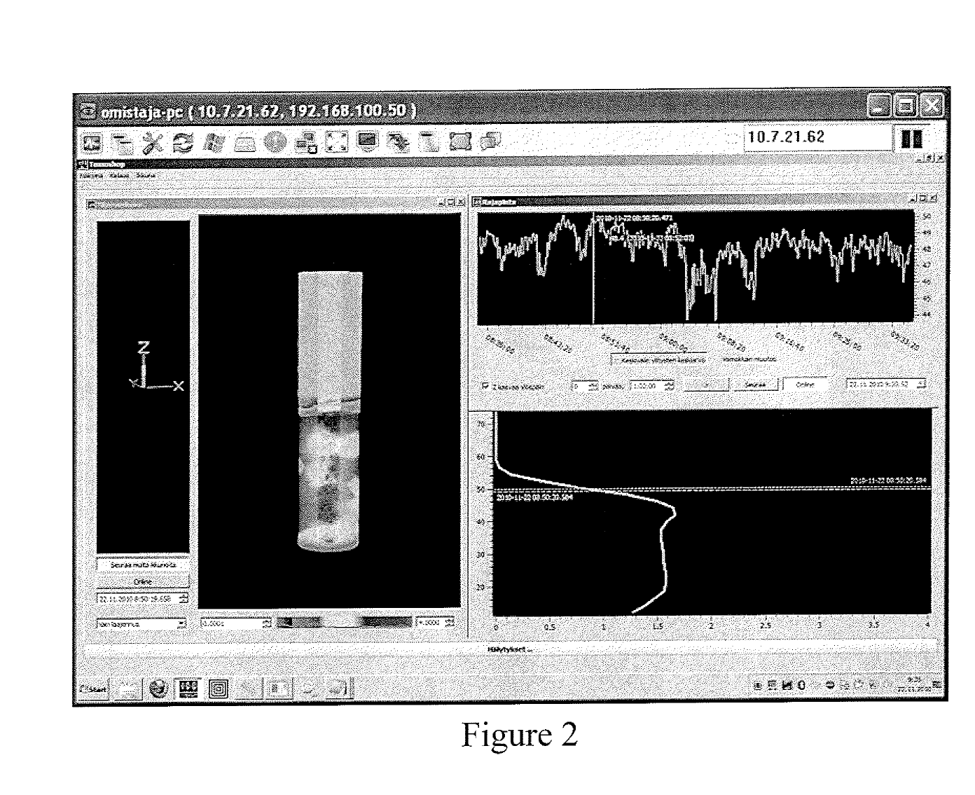

FIG. 2 illustrates exemplary measurement graphs showing a 3-dimensional profile of the material in a flotation tank (in the left side) and the location of the interface level as a function of time (in upper right side).

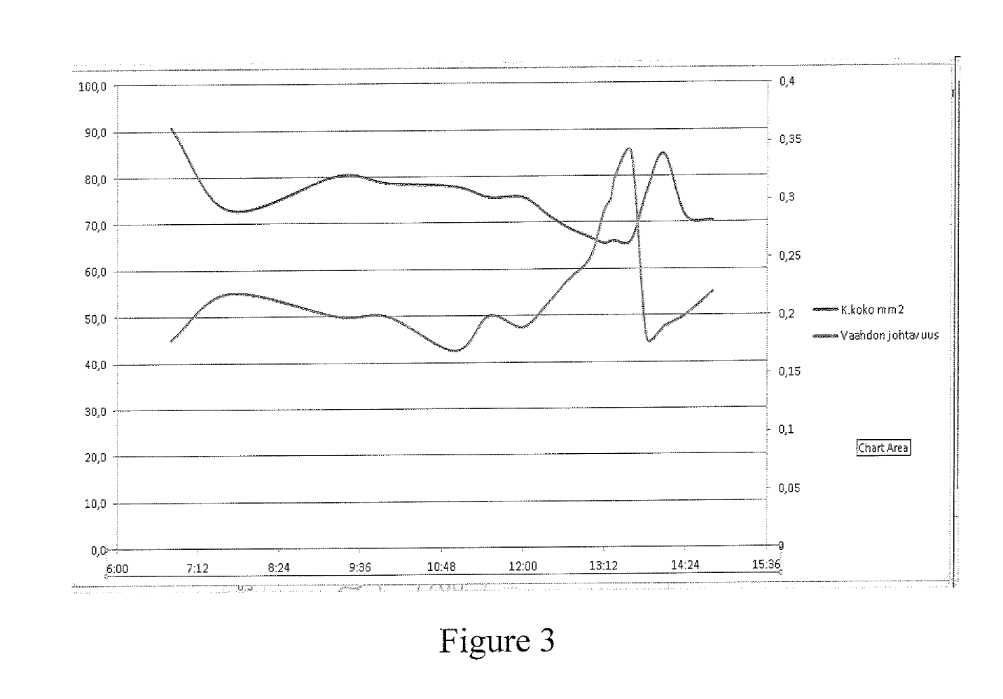

FIG. 3 illustrates curves of the average bubble size of the froth in square millimetres and the conductivity of the froth in mS/cm as a function of time, through an exemplary measurement arrangement. As it can be seen from FIG. 3, the bubble size remains between 65 . . . 80 mm² for a long time and also the conductivity stays between 0.17 . . . 0.23 mS/cm. As it can also be seen, the conductivity of the froth starts at first rising at around 13:00. The peak value of the conductivity is approximately 0.34 mS/cm after which the value quickly decreases back to 0.17 mS/cm. At around 13:50 the froth's average bubble size starts to rise, peaking at a value 85 mm² and decreasing back to the value 70 mm². It is clear from the measurement results that when the conductivity starts rising quickly, an alarm can be triggered much before than the bubble size starts to rise, giving much more time to control the process by adding a suitable substance (like xanthate or oil) or by controlling the speed of the material flow, for instance.

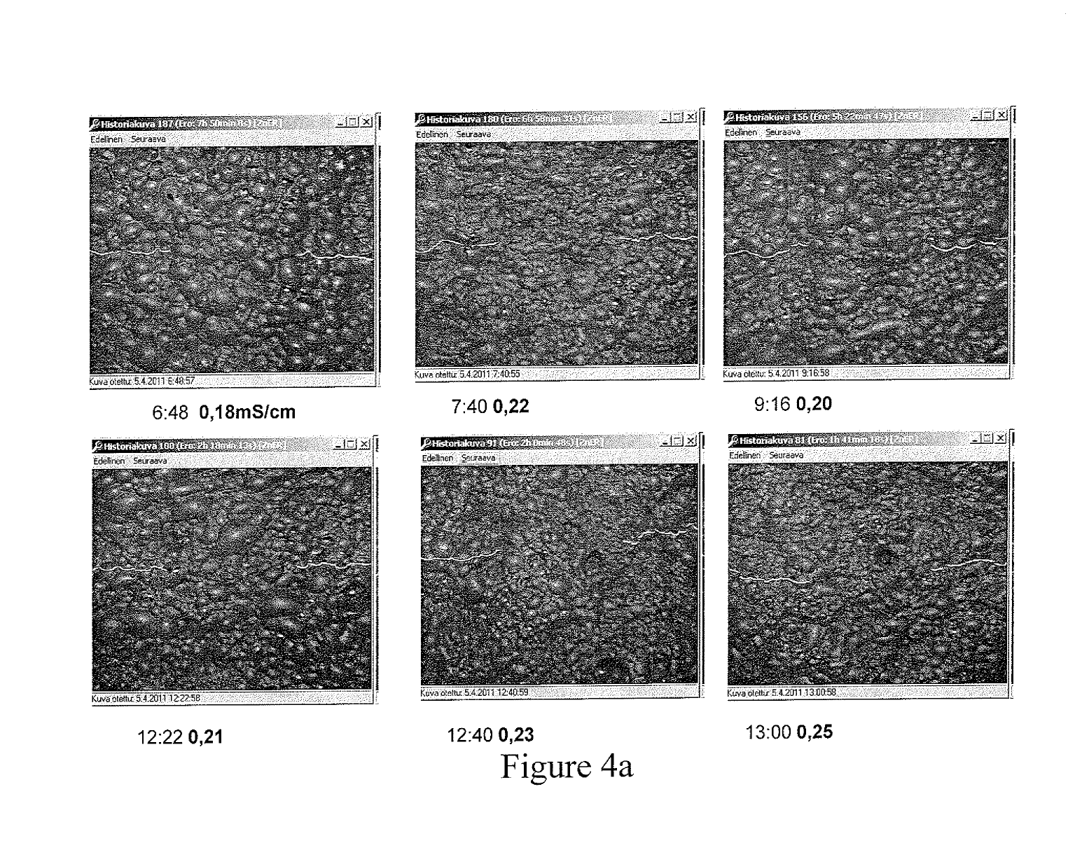

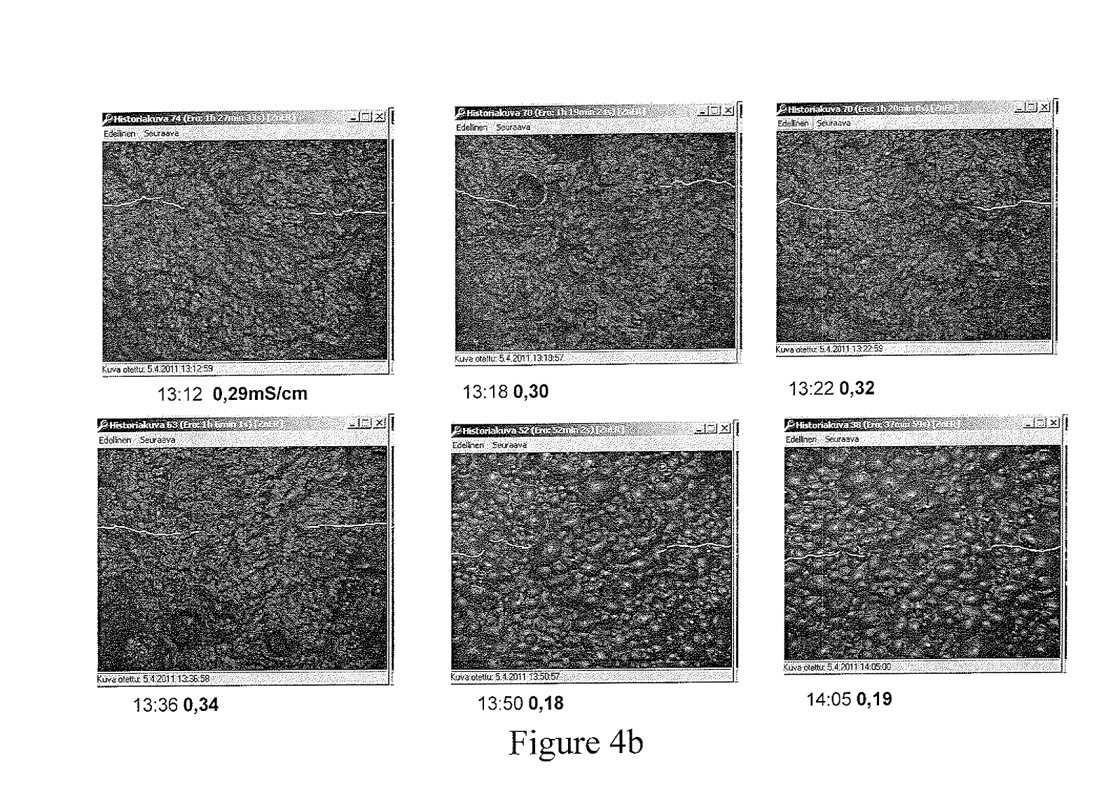

In one embodiment of the invention, visual information is acquired from the surface of the froth by taking a picture or several pictures (as a function of time) of the froth by a suitable camera or by other visual detection means (seen already in FIG. 1). Such pictures from an exemplary froth surface are shown in FIGS. 4a and 4b. The user or operator can use the picture(s) for achieving information through manual inspection and before possible manual controlling of the process. There is a clear dependency between the conductivity of the froth and the bubble size of the froth. It can be seen from FIGS. 4a-4b that larger bubble sizes correspond to smaller conductivity values. It should be noted that the conductivity is also generally dependent on a predominant temperature. Therefore, also the temperature can be measured with a suitable temperature sensor. The temperature sensor may be attached to the probe along the other electrodes. The temperature effect can be compensated by cancelling the effect of the temperature to the conductivity values as a further step in the calculation algorithm.

The present invention can be used in froth flotation processes as it is obvious from above. Furthermore, it can be used in any interface level measurement where conductivity value of the measured material can suddenly change as a function of height and where the measurement is based in electrical resistance tomography.

According to a further aspect of the invention, the measurement and controlling process is handled by a controller which comprises applicable software. The computations required in the invention may be implemented by a processor or other processing means, together with applying at least one computer program, and further using appropriate storage means (e.g. a memory) for saving and keeping all relevant measurement results and parameters for use in the controller. The execution of the computer program may also be performed by an internal or external server which is capable to exchange data with the probe arrangement and other hardware present in the measurement setup.

Advantages of the present invention compared to the prior art are numerous. The difference of the invention compared to reference Normi is that in Normi pipe geometry was used instead of a probe. In addition, no analysis of the froth or slurry is accomplished there. It is clear that the pipe geometry cannot be utilized in large flotation cells but only in small laboratory scale column flotation cells used in Normi.

Compared to simple conductivity probe techniques introduced e.g. in WO 93/00573, the present invention utilizes a model based computational approach that can take into account the geometry of the probe and the object as well as the obvious contamination problem of the approach. No separate conductivity cells are used but the mathematical model computes the conductivity profile directly from the current-voltage measurements. The froth-slurry interface is detected from the conductivity profile by analyzing the largest conductivity change in the profile. The properties of the slurry and froth media are further analyzed based on the conductivity distribution information.

The applicability and usefulness of the present invention are obvious from above. The present invention can be used to find out the properties of froth and/or slurry in froth flotation processes used e.g. in mineral engineering. Other possible application areas are pulp and paper industry (deinking processes) and also different separation processes such as zinc separation from the ore.

It is obvious to a person skilled in the art that with the advancement of technology, the basic idea of the invention may be implemented in various ways. The invention and its embodiments are thus not limited to the examples described above; instead they may vary within the scope of the claims.

1-24. (canceled)

25. A method, comprising
analyzing material in a container comprising slurry and/or froth and/or gas and/or a transitional area between the froth and the slurry, using at least one probe comprising together a plurality of electrodes capable of being in contact with the material, the analyzing further comprising:
a. injecting currents or voltages through at least two electrodes;
b. measuring voltages or currents, respectively, through the electrodes; and
c. determining conductivity distribution for the material using model based calculations, which comprise reconstruction of a vertical conductivity profile among the material.

26. The method according to claim 25, further comprising one or more of:
determining properties of the material based on the voltage or current measurement results, the properties comprising at least one of bubble size distribution, amount of solid materials in the froth and/or slurry, and stiffness of the froth,
estimating interface levels between froth-slurry and/or froth-gas interfaces and/or between the transitional area and froth and/or between the transitional area and slurry,
estimating the slurry-froth interface level and/or the froth-gas interface level by a step-like change in the conductivity value of the interface, and
estimating the density of the froth and/or the slurry, the density being proportional to the conductivity of the froth and/or the slurry.

27. The method according to claim 25, further comprising:
detecting electrodes locating in the gas, when the measured voltage or current by these electrodes is bound by a supply voltage of the system, or
when the measured voltage is beyond an allowed measurement voltage range.

28. The method according to claim 26, wherein the method is applied in a froth flotation process and the method further comprises:
controlling the froth flotation process based on at least one of the bubble size distribution, amount of solid materials in the froth and the slurry, stiffness of the froth and the interface levels between froth-slurry and/or froth-gas.

29. The method according to claim 28, wherein:
the controlling step is realized by at least one of adding at least one additive material changing the stiffness of the froth, choosing rate of input material feed, choosing rate of aeration, and changing parameters of grinding.

30. The method according to claim 25, further comprising:
monitoring contamination of the electrodes by measuring contact impedances between each electrode and the material to be analyzed.

31. The method according to claim 25, further comprising:
using in the analysis visual inspection data taken by a video camera.

32. The method according to claim 25, further comprising:
measuring temperature with the at least one probe; and
compensating conductivity values based on the measured temperature value.

33. A system for analyzing material, comprising:
a probe arrangement of at least one probe comprising together a plurality of electrodes capable of being in contact with the material in a container comprising slurry and/or froth and/or gas and/or a transitional area between the froth and the slurry;
a current source configured to inject currents or voltages through at least two electrodes;
measuring means configured to measure voltages or currents, respectively, through the electrodes; and
a processor configured to control the measurements, the processor being further configured to:
determine conductivity distribution for the material using model based calculations, which comprise reconstruction of a vertical conductivity profile among the material.

34. The system according to claim 33, wherein the processor is further configured to:
determine properties of the material based on the voltage or current measurement results, the properties comprising at least one of bubble size distribution, amount of solid materials in the froth and/or slurry, and stiffness of the froth.

35. The system according to claim 33, wherein the processor is further configured to:
estimate interface levels between froth-slurry and/or froth-gas interfaces and/or between the transitional area and froth and/or between the transitional area and slurry.

36. The system according to claim 33, wherein the processor is further configured to:
estimate the slurry-froth interface level and/or the froth-gas interface level by a step-like change in the conductivity value of the interface.

37. The system according to claim 33, wherein the processor is further configured to:
estimate the density of the froth and/or the slurry, the density being proportional to the conductivity of the froth and/or the slurry.

38. The system according to claim 33, wherein the processor is further configured to:
detect electrodes locating in the gas, when the measured voltage or current by these electrodes is bound by a supply voltage of the system, or
when the measured voltage is beyond an allowed measurement voltage range.

39. The system according to claim 35, wherein the system is applied in a froth flotation process and the processor is further configured to:
control the froth flotation process based on at least one of the bubble size distribution, amount of solid materials in the froth and the slurry, stiffness of the froth and the interface levels between froth-slurry and/or froth-gas.

40. The system according to claim 39, wherein the controlling step is realized by at least one of adding at least one additive material changing the stiffness of the froth, choosing rate of input material feed, choosing rate of aeration, and changing parameters of grinding.

41. The system according to claim 33, wherein the measuring means are further configured to:
monitor contamination of the electrodes by measuring contact impedances between each electrode and the material to be analyzed.

42. The system according to claim 33, wherein the system further comprises:
a video camera configured to take visual inspection data for use in the analysis.

43. The system according to claim 33, wherein the system further comprises:
a temperature probe configured to measure temperature and connected to the at least one probe; and the system is further configured to
compensate conductivity values based on the measured temperature value.

44. A computer program stored in a computer-readable medium, the computer program comprising code adapted to control the following steps, when executed on a data-processing system for analyzing material in a container comprising slurry and/or froth and/or gas and/or a transitional area between the froth and the slurry, using at least one probe comprising together a plurality of electrodes capable of being in contact with the material:
a. injecting currents or voltages through at least two electrodes;
b. measuring voltages or currents, respectively, through the electrodes; and
c. determining conductivity distribution for the material using model based calculations, which comprise reconstruction of a vertical conductivity profile among the material.
